(19) United States
(12) Patent Application Publication
(10) Pub. No.: US 2024/0330754 A1
(43) Pub. Date: Oct. 3, 2024

(54) USING MACHINE LEARNING TO EFFICIENTLY PROMOTE ECO-FRIENDLY PRODUCTS

(71) Applicant: ADOBE INC., San Jose, CA (US)

(72) Inventors: Soumya UNNIKRISHNAN, Austin, TX (US); Saina LAJEVARDI, Austin, TX (US); Michele SAAD, Austin, TX (US)

(21) Appl. No.: 18/194,501

(22) Filed: Mar. 31, 2023

(51) Int. Cl. G06N 20/00; G06N 3/0455; G06Q 30/018; G06Q 30/0283; G06Q 30/0601

(52) U.S. Cl. CPC G06N 20/00; G06N 3/0455; G06Q 30/018; G06Q 30/0283; G06Q 30/0625; G06Q 30/0631

(57) ABSTRACT

Methods and systems are provided for using machine learning to efficiently promote eco-friendly products. In embodiments described herein, a product descriptions associated with a product is obtained. The product description includes subject matter indicating an environmental effect of the product. Thereafter, a score for the product correlated to the environmental effect of the product is generated by a machine learning model based on the product description of the product. The score is then provided for presentation to a user to indicate the correlated environmental effect of the product.

### BACKGROUND

Eco-friendly products have become more readily available for purchase. Eco-friendly products, which may be referred to as environmentally-friendly or sustainable products, are products that are considered to have a positive environmental impact by affecting the environment less when compared to competing products. Businesses, however, face many challenges in achieving conversions (e.g., a purchase of an item) of their eco-friendly products. For example, oftentimes, e-commerce platforms do not clearly identify the products as eco-friendly and, as such, online consumers (e.g., shoppers or customers) do not know that the product being offered is eco-friendly. Further, even though shoppers report a positive attitude toward eco-friendly products, many shoppers seem unwilling to actually purchase the eco-friendly product.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, using machine learning to efficiently promote eco-friendly products. In this regard, embodiments described herein facilitate promoting eco-friendly products in accordance with eco-indicator product scores indicating an extent of eco-friendliness of products and/or eco-segment classifications indicating a classification or extent of environmental conscious behavior of customers. By promoting eco-friendly products in an appropriate and effective manner, it is more likely conversions associated with the eco-friendly products will be obtained. To promote eco-friendly products, eco-indicator product scores and/or eco-segment classifications of customers are determined. Such determinations can be generated using various machine learning models, some examples of which are described herein. Upon generating eco-indicator product scores and/or eco-segment classifications, such information can be used to promote eco-friendly products in an effective and efficient manner. For instance, in some cases, the eco-indicator product scores and/or eco-segment classifications can be used to generate and/or rank search results (e.g., such that eco-friendly products are ranked appropriately), to provide product recommendations, to optimize product pricing, and/or to generate decoy product recommendations.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example flow diagram of an eco-indicator scoring system for using machine learning to efficiently promote eco-friendly products, in accordance with embodiments of the present disclosure.

FIG. 4 provides an example flow diagram of an eco-segment customer classification system for using machine learning to efficiently promote eco-friendly products, in accordance with embodiments of the present disclosure.

FIG. 5 provides an example flow diagram of an eco-friendly product pricing system for using machine learning to efficiently promote eco-friendly products, in accordance with embodiments of the present disclosure.

FIG. 6 is a process flow showing a method for using machine learning to efficiently promote eco-friendly products, in accordance with embodiments of the present disclosure.

FIG. 7 is a process flow showing another method for using machine learning to efficiently promote eco-friendly products, in accordance with embodiments of the present disclosure.

FIG. 8 is a process flow showing another method for using machine learning to efficiently promote eco-friendly products, in accordance with embodiments of the present disclosure.

FIG. 9 is a process flow showing another method for using machine learning to efficiently promote eco-friendly products, in accordance with embodiments of the present disclosure.

FIG. 10 is a process flow showing another method for using machine learning to efficiently promote eco-friendly products, in accordance with embodiments of the present disclosure.

FIG. 11 is a process flow showing another method for using machine learning to efficiently promote eco-friendly products, in accordance with embodiments of the present disclosure.

FIG. 12 is a block diagram of an example computing device in which embodiments of the present disclosure can be employed.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

Businesses face many challenges in achieving conversions (e.g., a purchase of an item) of their eco-friendly products. Eco-friendly products, which may be referred to as environmentally-friendly or sustainable products, are products that are considered to have a positive environmental impact by affecting the environment less when compared to competing products. Oftentimes, e-commerce platforms do not clearly identify the products as eco-friendly, and online consumers (e.g., shoppers/customers) do not know that the product being offered is eco-friendly. The failure to identify whether a product is eco-friendly limits the ability of the business to target environmentally conscious customers, which would otherwise result in a conversion for the business. Further, even though shoppers report a positive attitude toward eco-friendly products, many shoppers are unwilling to actually purchase the eco-friendly product. For example, businesses may fail to achieve conversions for customers with a positive attitude towards eco-friendly products because the eco-friendly product is not priced competitively. As another example, businesses may fail to achieve conversions to customers when the product is not marketed to the optimal consumer with the optimal information to result in a conversion as some customers may be hesitant to learn how to use the eco-friendly product instead of simply purchasing the competing non-eco-friendly product that the customer is accustomed to using. As such, the success of the eco-friendly product in achieving the highest number of conversions will be highly dependent on identifying the particular eco-friendly product to optimal customers with the optimal information that will result in the conversion. Further, the success of the achieving the highest revenue for an eco-friendly product may also be highly dependent on selecting the optimal price for the eco-friendly product.

Currently, to identify or designate a product as eco-friendly, businesses must manually input whether the product is eco-friendly. Manually inputting whether a product is eco-friendly is time-consuming and resource intensive and, oftentimes, inaccurate as the business may market any product with an eco-friendly feature as eco-friendly regardless of the degree of eco-friendliness of the product. Moreover, when marketing an eco-friendly product to a customer, businesses generally rely on the searches of customers for an eco-friendly product. Therefore, business tend to fail to achieve conversions for eco-friendly products outside of specific customers that are searching for eco-friendly products. Further, the business generally estimates how to price the product and will often inaccurately price the eco-friendly product too high or too low to achieve the maximum amount of profit for the product.

Not only is the manual inputting of the eco-friendliness of each product time-consuming for the business, it is also time-consuming for customers searching for eco-friendly products to find the correct information and manually sift through information, and many times inaccurate information. For example, a user may search for a product and, upon obtaining search results, may manually go through the search results, or product information, to identify which items are economically friendly. Even when customers specifically search for eco-friendly products, the customer may receive inaccurate search results as various products or items may not appropriately reflect eco-friendly attributes. Further, the search results do not take into account whether, or an extent to which, the customer is environmentally conscious in their purchasing decisions.

Accordingly, unnecessary computing resources are utilized to designate and identify eco-friendly products in conventional implementations. For example, in accordance with identifying whether the product is eco-friendly, a consumer may utilize unnecessary resources selecting and reviewing each product description and/or regenerating searches to identify a desired product. Further, in attempting to achieve a desired conversion rate for a specific eco-friendly product, more resources may be used to present eco-friendly products to customers that would not be willing to purchase the eco-friendly product instead of optimizing the amount of resources necessary to target the consumers most willing to purchase the eco-friendly product.

With respect to consumers regenerating searches to identify a desired product or presenting the wrong products to the wrong consumers, computing and network resources are unnecessarily consumed to facilitate the searches and accesses to an unnecessary amount of product descriptions. For instance, computer input/output operations are unnecessarily increased in order to identify an eco-friendly product for a consumer searching for an eco-friendly product or an eco-friendly product that the consumer is willing to purchase. As one example, each time a search query is performed to identify a product that is eco-friendly for purchase, the information regarding the product must be searched for and located at a particular computer storage address of a storage device. The information must then be presented to the user. The user must review the information to manually determine the eco-friendliness of the product. Further, computing resources are unnecessarily used to repeat the process for multiple iterations in order to submit new or different search queries, along with the subsequent accessing, presentation and review process of the information related to each iteration of the multiple search query in order for the user to locate an eco-friendly product that the user would be willing to purchase. The searching for the product and locating of the information in order for the user to determine the eco-friendliness of the product is computationally expensive. The searching for the product and locating of the information in order for the user to determine the eco-friendliness of the product also increases latency. For example, when the information related to the product is located in a disk array and multiple iterations of the queries for products are issued, which is what occurs in existing technologies, there is unnecessary wear placed on the read/write head of the disk of the disk array. The search queries for products being repetitively issued also increases computer latency because the read/write head must manually access the disk to access the information related to the products for each of the multiple query iterations. Further, the processing of the multiple query iterations for products decreases the throughput for a network, increases the network latency, and increases packet generation costs. In this regard, usage of network resources is multiplied due to the amount of queries that must be executed by a user searching for an eco-friendly product, the subsequent access of the information from the results of the queries, as well as the generation of metadata in TCP/IP or any protocol used to generate the queries and subsequently access/presentation of the information.

As such, embodiments of the present disclosure are directed to using machine learning to efficiently promote eco-friendly products in an efficient and effective manner. In this regard, eco-friendly products can be efficiently and effectively identified on a scale of eco-friendliness of the product and priced efficiently thereby increasing consumer satisfaction, increasing the opportunity to result in a conversion (e.g., a product purchase) and meet sustainability goals, improving brand value or recognition with respect to the eco-friendliness of the product, and helping the planet by increasing the use of eco-friendly products.

Generally, and at a high level, embodiments described herein facilitate promoting eco-friendly products in accordance with eco-indicator product scores indicating an extent of eco-friendliness of products and/or eco-segment classifications indicating a classification or extent of environmental conscious behavior of customers. In this regard, by promoting eco-friendly products in an appropriate and effective manner, it is more likely conversions associated with the eco-friendly products will be obtained. As described herein, to promote eco-friendly products, eco-indicator product scores and/or eco-segment classifications are determined. Such determinations can be generated using various machine learning models, some examples of which are described herein. Upon generating eco-indicator product scores and/or eco-segment classifications, such information can be used to promote eco-friendly products in an effective and efficient manner. For instance, in some cases, the eco-indicator product scores and/or eco-segment classifications can be used to generate and/or rank search results (e.g., such that eco-friendly products are ranked appropriately), to provide product recommendations, to optimize product pricing, and/or to generate decoy product recommendations.

Advantageously, efficiencies of computing and network resources can be enhanced using implementations described herein. In particular, the eco-indicator score generation technology for a product and eco-segment classification generation technology for classifying customers, as well as generating/ranking of search results, providing product recommendations, optimizing product pricing and/or generating decoy product recommendations accordingly provides for a more efficient use of computing resources (e.g., higher throughput and reduced latency for a network, less packet generation costs, etc.) than conventional methods of searching for products and/or information accesses regarding those products in order to determine whether the product is eco-friendly. Further, the technology described herein enables a customer searching for an eco-friendly product to be presented with the eco-friendly product that the customer is most likely willing to purchase, which provides a more efficient use of computing resources by reducing the usage of network resources for performing unnecessary search query iterations. In this regard, the technology described herein enables a customer searching for eco-friendly products to be able to efficiently and effectively discover eco-friendly products with minimal search queries and minimal need to access product descriptions to look for the desired information, thereby reducing unnecessary computing resources used to process multiple search query iterations. The technology described herein results in less search queries over a computer network, which results in higher throughput, reduced latency and less packet generation costs as fewer packets are sent over a network. Therefore, the technology described herein conserves network resources.

In operation, to increase conversions for eco-friendly products, a machine learning model can be trained using a catalog of eco-friendly product descriptions and a catalog of non-eco-friendly products descriptions to predict the relative eco-friendliness of a product based on the product's corresponding description. Unseen products are then input into the machine learning model and rated with an eco-indicator score based on the description of the product to indicate the eco-friendliness of the product. Advantageously, when customers search for a product, eco-friendly products can be ranked higher in search results based on the eco-indicator score of the product.

To facilitate the optimal pricing of an eco-friendly product and increase the conversions of the eco-friendly product, a Multi-Armed Bandit (“MAB”) machine learning model can be used to converge from an initial price to an optimal price, which balances exploration of new prices with yielding minimum loss to the business offering the eco-friendly product when a suboptimal price is offered and chosen by a customer. Advantageously, the price that optimizes the amount of revenue for the business can be identified.

Further, a machine learning model can be used to analyze customer data to classify each customer in a specific eco-segment ranging from a committed eco-friendly product purchaser to a customer that is unaware or unwilling to purchase eco-friendly products. The customer data can be obtained from various sources and may include data pertaining to the eco-friendly purchasing behavior, environmental concern/skepticism, demographics, economic factors, and other factors that may influence the purchasing decision of the customer. Customers are then classified into different eco-segments indicating the likelihood that the customer is willing to purchase an eco-friendly product. Advantageously, when customers search for a product, the ranked eco-friendly products may also be ranked based on the eco-segment of the customer performing the search to increase the likelihood of conversion by the customer because the customer will be presented with eco-friendly products that other customers in the customer's segment previously purchased. The customer may also receive recommendations that similar customers with similar demographic data previously purchased the eco-friendly product to elicit conversions through social influence. The customer may also receive a recommended eco-friendly product along with a decoy product, the decoy product being a high-priced, low value product to elicit conversions through the decoy effect. Advantageously, social influence and decoy products in recommended products can be utilized to increase conversions of the eco-friendly product.

Various terms are used throughout the description of embodiments provided herein. A brief overview of such terms and phrases is provided here for ease of understanding, but more details of these terms and phrases is provided throughout.

An eco-friendly product, which may be referred to as an environmentally-friendly or sustainable product, is a product that is considered to have a positive environmental impact by affecting the environment less when compared to competing products. A non-eco-friendly product is a product that is considered to have a negative environmental impact by affecting the environment more when compared to competing products.

An eco-indicator product score or eco-indicator score is a relative score of a product to indicate the eco-friendliness (i.e., how eco-friendly the product is) of the product in comparison to other products. For example, the eco-indicator can be a ranking out of five, where a score of one would indicate that the product is not relatively eco-friendly and a score of five would indicate that the product is very eco-friendly. Any scoring or rating based on any given range is within the scope of the invention.

Environmental behavior refers to habits of an individual (e.g., a customer/shopper/consumer or potential customer/shopper/consumer, each of these terms being used interchangeably) with respect to the environment and may be based on information such as demographic factors, eco-friendly product/service purchasing data, environmental activism, concern or skepticism, economic circumstances of the individual, and any other data which tends to show how an individual's habits with respect to the environment.

An eco-segment or eco-segment classification/segment for a customer refers to a data segment or classification of a group of customers to classify the environmental behavior of a customer. In this regard, customers are typically at various stages in their sustainability practices. For example, while some customers have opted for make sustainable choices consistently and for a long time, other customers may be unfamiliar to such choices. Further, other customers may not be interested or able to make sustainable choices regardless of how products are marketed. As an example, customers may be segmented or classified into eco-segments identifying the customer's environmental behavior as likely committed, pro-active, unsure, unaware, or against purchasing eco-friendly products. The eco-segments are provided for exemplary purposes and any amount or type of eco-segments are within the scope of this invention. Further, there can be sub-classifications of customers within specific eco-segments. For example, a customer may be a committed purchaser of eco-friendly products, but may be more price-conscious in their purchasing decisions. In this regard, the customer would be not necessarily be presented with an eco-friendly product with the highest eco-indicator score, but rather an eco-friendly product that takes into account the price of the product. Any sub-classifications of customers within eco-segments are within the scope of this invention and may be referred to eco-segments generally.

A product description refers to text, images, and any other data describing the product or how the product is manufactured. The product descriptions may be present in any type of database. The database of product descriptions may be referred to as a catalog, set, or listing of product descriptions.

A decoy product refers to a high-priced, low-value (i.e., less environmentally-friendly or a poor substitute product for the product the customer is attempting to search for or purchase) product to elicit conversions through the decoy effect. Introducing a decoy product into a choice set can induce a customer to shift their choices to sustainable products. For example, in scenarios where products added to the cart are unavailable or out of stock, in some embodiments, customers are provided with choice sets or substitution sets that that use the decoy effect. The decoy product can steer attention of customers to sustainable products to further improve conversions. As a further example, in some embodiments, default choice option can automatically select sustainable products while the unselected other options may use the decoy effect. The shopper is free to choose whichever option they want while abstaining to choosing an option results in the pre-selected option. In this example the decoy effect may be utilized to steer the customer to purchase the preselected, default choice.

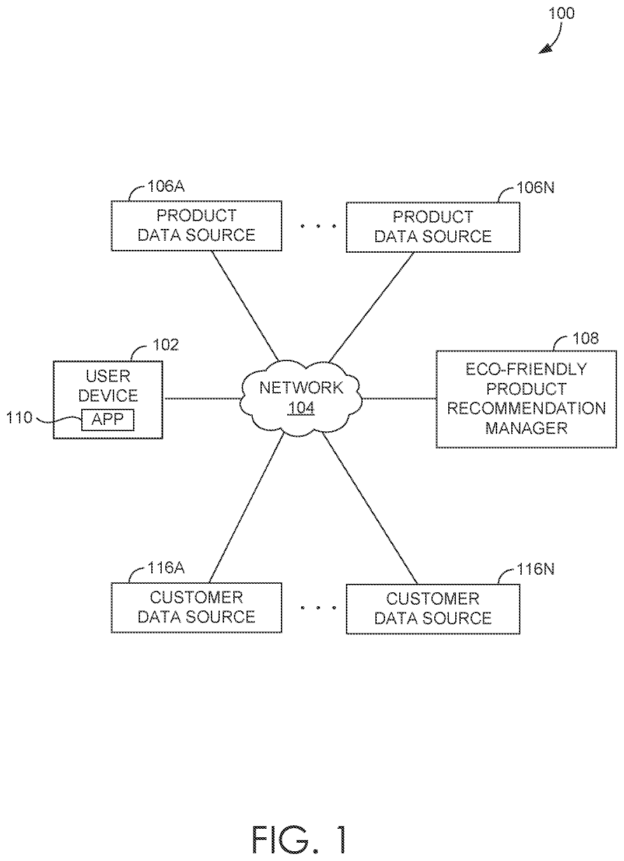

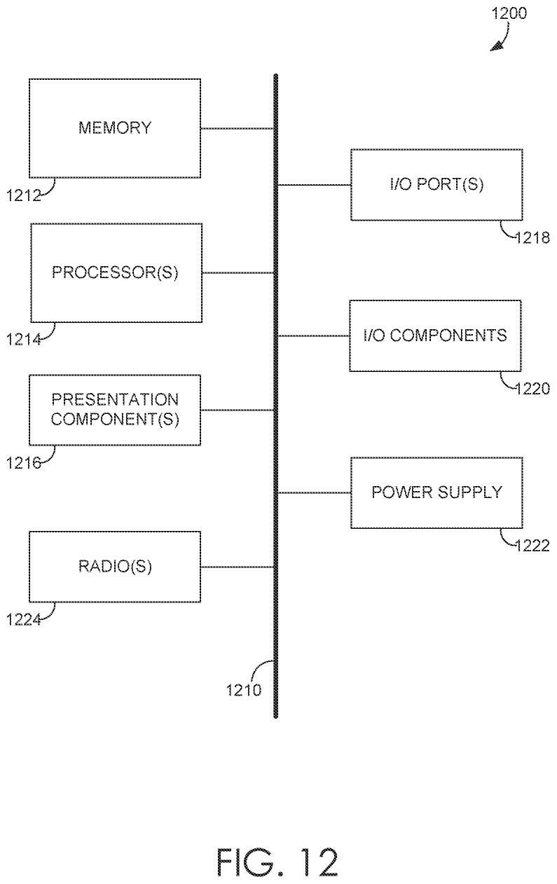

Turning to FIG. 1, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 12.

It should be understood that operating environment 100 shown in FIG. 1 is an example of one suitable operating environment. Among other components not shown, operating environment 100 includes a user device 102, network 104, product data sources 106A-N, customer data sources 116A-N, and eco-friendly product recommendation manager 108. Each of the components shown in FIG. 1 can be implemented via any type of computing device, such as one or more of computing device 1200 described in connection to FIG. 12, for example. These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., a customer or a business). For example, in some implementations, such devices are the type of computing device described in relation to FIG. 12. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice. The application(s) may generally be any application capable of facilitating a search for products and/or the presentation of products to the user so the user can decide whether to purchase one of the products. In some implementations, the application(s) comprises a web application, which can run in a web browser, and could be hosted at least partially server-side (e.g., via eco-friendly product recommendation manager 108). In addition, or instead, the application(s) can comprise a dedicated application. In some cases, the application is integrated into the operating system (e.g., as a service). As one specific example application, application 110 may be an e-commerce website or application. Such an application may be accessed via a mobile application, a web application, or the like. The e-commerce website or application can include catalogs or lists of products for sale through the e-commerce website or application. The e-commerce website or application can include corresponding product descriptions for each of the products listed for sale through the website or application. Customers use the e-commerce website or application to search for products, and the e-commerce website or application provides search results and ranks search results. The product description can include an eco-indicator score for display on the e-commerce website or application. The search results and product recommendations from the e-commerce website or application may be ranked and presented to the customer as described herein.

User device 102 can be a client device on a client-side of operating environment 100, while eco-friendly product recommendation manager 108 can be on a server-side of operating environment 100. Eco-friendly product recommendation manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or eco-friendly product recommendation manager 108 to remain as separate entities.

Application 110 operating on user device 102 can generally be any application capable of facilitating the exchange of information between the user device(s) and the eco-friendly product recommendation manager 108 in carrying out identifying, recommending, and/or presenting eco-friendly products. In some implementations, the application(s) comprises a web application, which can run in a web browser, and could be hosted at least partially on the server-side of environment 100. In addition, or instead, the application(s) can comprise a dedicated application. In some cases, the application is integrated into the operating system (e.g., as a service). It is therefore contemplated herein that “application” be interpreted broadly. In embodiments, user interactions with application 110 can be monitored (e.g., via a server) to identify interactions of a user with eco-friendly products or other applications indicating the environmental behavior of the user. For example, user interactions with application 110 can be monitored, including selecting or clicking on a particular product, electronically purchasing a particular product, navigating to a particular website, entering and/or existing a retail brick-and-mortar store, and the like.

In accordance with embodiments herein, the application 110 can use machine learning to efficiently promote eco-friendly products to facilitate increasing conversions for eco-friendly products in an efficient and effective manner. In operation, a user can search for products (e.g., a user search for products to purchase on an e-commerce website) via a graphical user interface provided via the application 110. The eco-friendly product recommendation manager 108 can identify and score eco-friendly products, identify the optimal price for an eco-friendly products, identify and classify customers into eco-segments, and provide search results or recommendations of eco-friendly products for the specific customer. In this regard, the eco-friendly product recommendation manager 108 provides search results or recommendations of eco-friendly products for the specific customer to application 110 of the user device. The search results or recommendations can be displayed via a display screen of the user device. The search results or recommendations can be presented in any manner. In operation, the eco-friendly product recommendation manager 108 can obtain user data from user device 102 (e.g., the customer's customer data), customer data from customer data sources 116a-116n, and product data (e.g., product names, product prices, product descriptions, etc.) from product data sources 106a-106n. Data sources 106a-106n and 116a-116n may be any type of source providing data (e.g., product data and customer data). Generally, the eco-friendly product recommendation manager 108 receives data from any number of devices. As such, the eco-friendly product recommendation manager 108 can identify and/or collect data from various user devices, such as user device 102, and sources, such as data sources 106a-106n and 116a-116n. In this regard, the eco-friendly product recommendation manager 108 can retrieve or receive data collected or identified at various components, or sensors associated therewith.

As described, in some cases, the eco-friendly product recommendation manager 108 can retrieve or receive customer data from the user device 102 and customer data sources 116a-116n. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, sports data, health data, and nearly any other source of data that may be used to identify the customer or the eco-segment of the customer, as described herein.

Additionally or alternatively, the eco-friendly product recommendation manager 108 can retrieve or receive product data from product data sources 106a-106n. By way of example and not limitation, product data within a dataset may include data that is sensed or determined from one or more sensors, such as product names, product prices, product descriptions, product purchase history, product price history, and nearly any other source of data that may be used to identify the product or information about the product, as described herein.

Such customer data and product can be initially collected at remote locations or systems and transmitted to a data store for access by eco-friendly product recommendation manager 108. In accordance with embodiments described herein, customer and product data collection may occur at data sources 106a-106n and 116a-116n, respectively. In some cases, data sources 106a-106n and 116a-116n, or portion thereof, may be client devices, that is, computing devices operated by businesses (e.g., product listings or catalogs, etc.) or customers (e.g., online product searchers or viewers, online product customers, etc.), respectively, for example. As such, client devices, or components associated therewith, can be used to collect various types of customer and product data. For example, in some embodiments, customer data may be obtained and collected at a client device operated by a customer via one or more sensors, which may be on or associated with one or more client devices and/or other computing devices. As another example, in some embodiments, customer data or product data may be obtained and collected at an e-commerce website being visited by a customer via one or more sensors, which may be on or associated with one or more client devices and/or other computing devices. As used herein, a sensor may include a function, routine, component, or combination thereof for sensing, detecting, or otherwise obtaining information, such as customer and product data, and may be embodied as hardware, software, or both.

In addition or in the alternative to data sources 106a-106n and 116a-116n including client devices, data sources 106a-106n and 116a-116n may include servers, data stores, or other components that collect customer or product data, for example, from client devices associated with customers or e-commerce websites. For example, in interacting with a client device, datasets may be captured at data sources 106a-106n and 116a-116n and, thereafter, such customer data can be provided to eco-friendly product recommendation manager for storage. As another example, in interacting with an e-commerce website, datasets may be captured at data sources 106a-106n and 116a-116n and, thereafter, such product or customer data can be provided to eco-friendly product recommendation manager for storage. Product and customer data may additionally or alternatively be obtained from an external server, for example, that collects product or customer data. Product and customer data can be obtained at a data source periodically or in an ongoing manner (or at any time) and provided to the eco-friendly product recommendation manager 108 to facilitate providing search results or recommendations of eco-friendly products for the specific customer. Product and customer data can be manually input into the eco-friendly product recommendation manager 108. For example, a catalog of previously-identified eco-friendly products or a catalog of previously identified non-eco-friendly products may be manually input into the eco-friendly product recommendation manager 108 in order to train a machine learning model operating at the eco-friendly product recommendation manager 108.

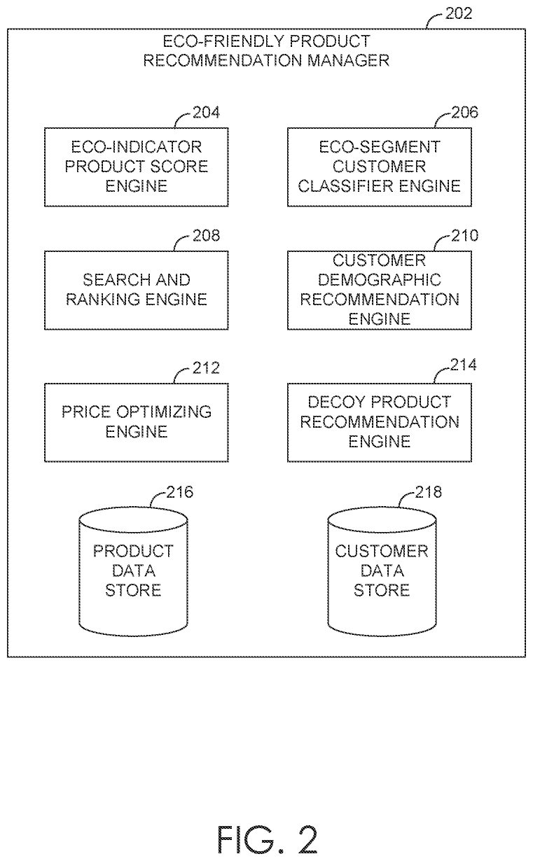

As described herein, eco-friendly product recommendation manager 108 can facilitate identifying, scoring and pricing eco-friendly products; identifying and classifying customers by eco-segment; and/or providing search results or recommendations of eco-friendly products for the specific customer. Eco-friendly product recommendation manager 108 can be or include a server, including one or more processors, and one or more computer-readable media. The computer-readable media includes computer-readable instructions executable by the one or more processors. The instructions can optionally implement one or more components of eco-friendly product recommendation manager, described in additional detail below with respect to eco-friendly product recommendation manager 202 of FIG. 2.

At a high level, eco-friendly product recommendation manager 108 performs various functionality to facilitate efficient and effective eco-friendly product management, such as identifying and scoring eco-friendly products, identifying the optimal price for an eco-friendly products, identifying and classifying customers into eco-segments, and providing search results or recommendations of eco-friendly products for the specific customer. In this regard, eco-friendly product recommendation manager 108 can provide search results or recommendations of eco-friendly products for the specific customer to application 110 of the user device. The search results or recommendations can be displayed via a display screen of the user device and may be presented in any manner. Further, eco-friendly product recommendation manager 108 can provide data regarding products and customers (e.g., the eco-indicator scores of the products, the eco-segments of the customers, and any other data) to application 110 of the user device for use by the business. The data can be displayed via a display screen of the user device and may be presented in any manner.

For cloud-based implementations, the instructions on eco-friendly product recommendation manager 108 can implement one or more components, and application 110 can be utilized by a user to interface with the functionality implemented on eco-friendly product recommendation manager 108. In some cases, application 110 comprises a web browser. In other cases, eco-friendly product recommendation manager 108 may not be required. For example, the components of eco-friendly product recommendation manager 108 may be implemented completely on a user device, such as user device 102. In this case, eco-friendly product recommendation manager may be embodied at least partially by the instructions corresponding to application 110.

Thus, it should be appreciated that eco-friendly product recommendation manager 108 may be provided via multiple devices arranged in a distributed environment that collectively provide the functionality described herein. Additionally, other components not shown may also be included within the distributed environment. In addition, or instead, eco-friendly product recommendation manager 108 can be integrated, at least partially, into a user device, such as user device 102. Furthermore, eco-friendly product recommendation manager 108 may at least partially be embodied as a cloud computing service.

Referring to FIG. 2, aspects of an illustrative eco-friendly product recommendation management system are shown, in accordance with various embodiments of the present disclosure. At a high level, the eco-friendly product recommendation management system can identify and score eco-friendly products with an eco-indicator score, optimize the price for the eco-friendly product, identify and classify customers based on their corresponding eco-segment, and provide search results or recommendations of eco-friendly products for a specific customer. As described herein, an eco-indicator score refers to a score that indicates the relative eco-friendliness of a product when compared to other products. An eco-segment customer classifier refers to a classification of a customer indicating the likelihood of a customer to engage in eco-friendly behavior and/or purchase eco-friendly products. In embodiments described herein, the eco-friendly product recommendations management system provides machine learning approaches to narrow the intention-action gap for customers and businesses with respect to eco-friendly product offerings. In this regard, the eco-friendly product recommendation management system can provide search results or recommendations of eco-friendly products for the specific customer based on the customer's eco-segment to maximize the likelihood that a specific customer will purchase a specific eco-friendly product. As well, the eco-friendly product recommendation management system can provide data regarding the products and customers to the business so that the business can analyze data regarding its eco-friendly product offerings and the eco-segments of its customers.

As shown in FIG. 2, eco-friendly product recommendation manager 202 includes an eco-indicator product score engine 204, an eco-segment customer classifier engine 206, a search and ranking engine 208, a customer demographic recommendation engine 210, a price optimizing engine 212, a decoy product recommendation engine 214, a product data store 216, and a customer data store 218. The foregoing components of eco-friendly product recommendation manager 202 can be implemented, for example, in operating environment 100 of FIG. 1. In particular, those components may be integrated into any suitable combination of user devices 102 and/or eco-friendly product recommendation manager 108.

Product data store 216 and customer data store 218 can store computer instructions (e.g., software program instructions, routines, or services), data, and/or models used in embodiments described herein. In some implementations, product data store 216 and customer data store 218 stores information or data received or generated via the various components of eco-friendly product recommendation manager 202 and provides the various components with access to that information or data, as needed. Although depicted as two components, product data store 216 and customer data store 218 may be embodied as one or more data stores or each as one or more data stores. Further, the information in product data store 216 and customer data store 218 may be distributed in any suitable manner across one or more data stores for storage (which may be hosted externally).

In embodiments, data stored in product data store 216 includes product names, prices, descriptions, product description training data, and/or the like. For example, product data store 216 can store product descriptions, (e.g., text, images, and any other data describing the product or how the product is made) for a set or catalog of products, along with the corresponding eco-indicator score after the eco-indicator score is determined for the product. Product data store 216 can also store a set or catalog of product descriptions to train an eco-indicator machine learning model of eco-indicator product score engine 204. For example, product data store 216 can store a manually curated set of eco-friendly product descriptions and a manually curated set of non-eco-friendly product descriptions to be used as training data for the eco-indicator product score engine 204. In some cases, eco-friendly product recommendation manager 202, or components associated therewith, can obtain product data from client devices (e.g., a user device(s)). In other cases, product data can be received from one or more data stores in the cloud, or data generated by the eco-friendly product recommendation manager 202.

In embodiments, data stored in customer data store 218 includes customer data (e.g., characteristics, behavior or interaction data, and/or the like). For example, customer data store 218 can store customer data from various sources, such as social platforms, questionnaires/surveys, e-commerce platforms, or any data source that provides data about the customer. The customer data can include data regarding the customers' demographic factors, eco-friendly buying behavior, environmental activism, environmental concern, environmental skepticism, and economic factors, and any other data regarding the customers. In some cases, eco-friendly product recommendation manager 202, or components associated therewith, can obtain customer data from client devices (e.g., a user device(s)). In other cases, customer data can be received from one or more data stores in the cloud, or data generated by the eco-friendly product recommendation manager 202.

The eco-indicator product score engine 204 is generally configured to automatically infer eco-indicator scores for products. In embodiments, eco-indicator scores are inferred or determined based on the eco-friendliness of an item (e.g., from merchant/business catalogs) using NLP and/or machine learning techniques. Eco-indicator product score engine 204 can include rules, conditions, associations, models, algorithms, or the like to generate an eco-indicator product score. Eco-indicator product score engine 204 may take on different forms depending on the mechanism used to determine an eco-indicator product score. For example, eco-indicator product score engine 204 may comprise a statistical model, fuzzy logic, neural network, finite state machine, support vector machine, logistic regression, clustering, or machine-learning techniques, similar statistical classification processes, or combinations of these to identify an eco-indicator score of a product.

In one embodiment, the eco-indicator product score engine 204 may include natural language processing (“NLP”). In this regard, the eco-indicator product score engine 204 may utilize NLP techniques to extract data, such as keywords, embeddings, etc., from product descriptions and reduce noise of the data through techniques such as lemmatization and other NLP techniques. The data extracted by the NLP model may be input into a trained machine learning model to determine the eco-friendliness or non-eco-friendliness of a product. As can be appreciated, in some embodiments, a machine learning model may be specifically trained for use in determining the eco-indicator score for a product. For example, a particular machine learning model may be trained to learn embeddings or keywords specific to eco-friendly products based on their corresponding product description. Such a machine learning model may be trained, for example, by feeding the model with product description or content related to eco-friendly products.

In this regard, the eco-indicator product score engine 204 can be a machine learning model that is trained using a manually curated set of eco-friendly product descriptions to output an eco-indicator score for an input product indicating how eco-friendly a product is based on the input product's product description. For example, an auto-encoder model obtains data characteristics from product descriptions, categorical product attributes, and pricing information from catalogs of brands that sell eco-friendly products or a manually curated set of brands or products. The auto-encoder model can use supervised and/or unsupervised learning in order to extract features indicating the eco-friendliness of a product without the need for expert knowledge on characteristics of eco-friendly products and the manual entry thereof. The latent representation of the input features extracted by the auto-encoder model is used to learn a classifier model that infers the eco-friendliness of products in unseen descriptions of products in product catalogs. In some embodiments, the auto-encoder layer and classification layer can be trained separately. In some embodiments, the auto-encoder layer and the classification layer can be trained simultaneously. The classifier model can label unseen products with eco-indicator scores as the unseen products, along with the corresponding description of the input product, are input into the machine learning model. In some embodiments, the eco-indicator product score engine 204 can additionally or alternatively be trained using a manually curated set of non-eco-friendly product descriptions.

After the auto-encoder model or layer and classifier model or layer of the machine learning model of the eco-indicator product score engine 204 are trained, products, previously unseen by the machine learning model, can be input into the machine learning model in order to output an eco-indicator product score for the input product. For example, when a description of a new product is input into eco-indicator product score engine 204, the data is preprocessed through a NLP model for lemmatization, removing stop words, normalizing data, and other NLP techniques in order to remove excess noise. It can be appreciated that the input vector can be varying in size based on the length of the product description. The preprocessed data is then input into the auto-encoder model.

The auto-encoder model is trained to extract features from higher dimensional data of an input product description in order to reduce the dimensionality of the input data for more efficient representation of features that indicate the eco-friendliness of the product. Initially, the auto-encoder model includes an encoder layer, a bottleneck layer, and a decoder layer. The encoder layer compresses the input data from the product description of the product to the feature representation of the bottleneck layer. The decoder layer recreates or reconstructs the input data from the compressed input data of the bottleneck layer. The auto-encoder model is trained so that the output of the decoder layer maintains the features necessary to indicate the eco-friendliness of the product from the input product, while efficiently reducing the dimensionality of the input data into the reduced dimensionality of the bottleneck layer.

After the autoencoder model is trained, the decoder layer and output from the decoder layer are not necessary for determining the eco-indicator score as the output from the bottleneck layer represents the compressed and most efficient representation of the features of the input product description to indicate the eco-friendliness of the product. Thus, after the auto-encoder model is trained, the feature representations exit the auto-encoder model through the bottleneck layer and enter the classification layer. In some embodiments, when the classification layer is being trained simultaneously with the auto-encoder model, the output from the decoder layer (i.e., the reconstructed input data) may be used to train the classification layer, along with the feature representations of the bottleneck layer.

In the classification layer, the feature representations are input and a classification representing the eco-friendliness of the compressed input product description is output. The classifier (i.e., the classification layer) is trained (using the set of eco-friendly product descriptions and/or the set of non-eco-friendly product descriptions) to output a classification representing the eco-friendliness of the product using the feature representations output from the bottleneck layer of the auto-encoder model. In some embodiments, the classification layer outputs a probability that a product is eco-friendly. The probability output by the classification layer for the input product can enter a scoring layer, which then assigns a score for the input product. For example, the eco-indicator score may be any score on any given range, such as zero to five star rating where the inferred eco-friendliness of the product increases as the product's eco-indicator score approaches five stars. In some embodiments, the classification layer may output a binary determination and the scoring layer outputs whether a product is eco-friendly or non-eco-friendly. In some embodiments, the classification layer may be a string that may indicate relative levels of the eco-friendliness of the input product, and the output from the eco-scoring layer is the level of eco-friendliness of the product. By using the auto-encoder model and classification layer of the machine learning model (or as separate machine learning models), merchants, who would not otherwise know that one of their products is eco-friendly, can use the machine learning model to identify the eco-friendliness of their products based on eco-friendly materials or processes within the product description of their product.

In some embodiments, the eco-indicator product scores from the eco-indicator product score engine 204 can be output into a catalog of products stored in the product data store 216 that can be accessed by a user interface. In this regard, businesses or customers can review the eco-indicator product scores for various products stored in the catalog to make decisions regarding the eco-friendliness of the products. In some embodiments, the eco-indicator product scores from the eco-indicator product score engine 204 can be output as a label for a product presented on an e-commerce website for display in a user interface. In this regard, a customer can see the eco-indicator for a product as it is presented on the e-commerce website (e.g., search results for products, recommendations for products, etc.).

In some embodiments, eco-friendly product descriptions are identified based on human input in order to train the autoencoder model and classifier model of the machine learning model of the eco-indicator product score engine 204. In this regard, a human(s) (e.g., a domain expert) can manually curate an initial list of eco-friendly product descriptions. For example, a set of marketers, researchers, or other set of individuals can provide or input a list of products and their corresponding product description that are deemed to be eco-friendly or non-eco-friendly. Additionally or alternatively, the eco-indicator product score engine 204 can include feedback to optimize the machine learning model. In this regard, a product eco-indicator score can be identified based on user indications (e.g., based on interactions) and/or feedback. For example, in some cases, the eco-indicator score engine 204 may output a product as eco-friendly and a user (e.g., a customer or a business) may identify the product as non-eco-friendly or vice versa. In this regard, the feedback may be used to further train the machine learning model. As an additional example, the eco-friendliness of certain products or certain characteristics of products may change over time. For example, due to changes to the product, the manufacturing of a product, or new information regarding the eco-friendliness of a certain component, one product may be currently more eco-friendly or non-eco-friendly than at a previous point in time. As can be appreciated, the eco-indicator product score engine 204 may store the initial set of eco-friendly products and/or product descriptions via a data store, such as product data store 216 and continuously or periodically update the eco-indicator score over time.

The eco-segment customer classifier engine 206 is generally configured classify customers into eco-segments. An eco-segment or eco-segment classification for a customer refers to a data segment or group of customers as a classification/segment to classify the environmental behavior of a customer. As an example, customers may be segmented or classified into eco-segments identifying the customer's environmental behavior as likely committed, pro-active, unsure, unaware, or against purchasing eco-friendly products. In this regard, classifying customers into eco-segments allow the business to leverage inferred sustainability related to customer segments in order for the eco-friendly product recommendation manager 202 to deploy customized sustainability nudging strategies to rank eco-friendly products as a function of customer segments. The use of nudging techniques based on the eco-segment of the customer allows the business to narrow the intention-action gap for the customer based on the specific customer segment to promote the eco-friendly product with the highest likelihood of conversion by the specific customer.

Eco-segment customer classifier engine 206 can include rules, conditions, associations, models, algorithms, or the like to classify customers into eco-segments. Eco-segment customer classifier engine 206 may take on different forms depending on the mechanism used to determine an eco-segment for a customer. For example, eco-segment customer classifier engine 206 may comprise a statistical model, fuzzy logic, neural network, finite state machine, support vector machine, logistic regression, clustering, or machine-learning techniques, similar statistical classification processes, or combinations of these to classify customers into eco-segments. In one embodiment, the eco-segment customer classifier engine 206 may include NLP. In this regard, the eco-indicator product score engine 204 may utilize NLP techniques to extract data, such as keywords, embeddings, etc., from various customer data sources and reduce noise of the data through techniques such as lemmatization and other NLP techniques. The data extracted by the NLP model may be input into a trained machine learning model (or to train the machine learning model) to classify the customers into eco-segments. As can be appreciated, in some embodiments, a machine learning model may be specifically trained for use in determining the eco-segment for a customer. For example, the eco-segment customer classifier engine 206 can use a particular machine learning model for segmentation/classification of customers into eco-segments based on the customer's affinity for eco-friendly products. Such a machine learning model may be trained, for example, by feeding the model with customer data from various sources.

In this regard, the eco-segment customer classifier engine 206 can be an eco-segment machine learning model that is trained to segment customers into eco-segments based on the likelihood that a customer will purchase eco-friendly products based on their environmental behavior. As an example, to classify or segment shoppers based on their corresponding environmental behavior, a set of variables can be chosen to identify the customer's consumption patterns, such as social, demographic, economic, and behavioral variables. The correlation of these variables with eco-friendliness is determined, for example, through surveys, observing ethical and pro-environmental behavior of shoppers on ecommerce websites and social platforms, etc. The features of the customers (i.e., the consumption patterns of the customers) are then extracted by the eco-segment customer classifier engine 206 and can include features such as demographic factors, eco-friendly buying behavior, environmental concern, environmental activism, environmental skepticism, economic factors, and similar features. These features are fed into a machine learning model of the eco-segment customer classifier engine 206 to segment the customers into eco-segments. For example, the eco-segment machine learning model can be a k-means clustering model and can be supervised or unsupervised. In order to train the eco-segment machine learning model to classify a customer into a specific eco-segment, the eco-segments classifications or the output of the eco-segment machine learning model can be compared to ground truth to identify errors, which are backpropogated to train the machine learning model.

In accordance with training the eco-segment machine learning model, the eco-segment customer classification engine 206 utilizes the trained eco-segment machine learning model to classify customers into eco-segments. In some embodiments, the segmentation of customers into eco-segments is performed online in-advance. In some embodiments, the segmentation of customers into eco-segments is performed in real-time (e.g., as the customer performs a search for products, the eco-segment machine learning model extracts the environmental behavior of the customer from various data sources and classifies the customer accordingly). The eco-segments can be any range of likelihood that a customer will purchase an eco-friendly product. For example, the eco-segments can include customers committed to eco-friendly products, customers that are pro-active about eco-friendly products but not fully committed, customers that are unsure about purchasing eco-friendly products, customers that are unaware of eco-friendly products, customers that are unwilling to purchase eco-friendly products, and other similar customer segments. Further, there can be sub-classifications of customers within specific eco-segments. For example, a customer may be a committed purchaser of eco-friendly products, but may be more price-conscious in their purchasing decisions. In this regard, the customer would be not necessarily be presented with an eco-friendly product with the highest eco-indicator score, but rather an eco-friendly product that takes into account the price of the product. The sub-classifications of customers can be referred to as sub-classifications or generally as eco-segments.

In this regard, once eco-segments are identified by the eco-segment customer classifier engine 206, promotions (e.g., ranking of certain eco-friendly products by search and ranking engine 208, product recommendations from customer demographic recommendation engine 210, recommended product/decoy product recommendations from decoy product recommendation engine 214, etc.) from the eco-friendly product recommendation manager 202 are designed to act as eco-nudges for shoppers who might not organically make an eco-friendly purchase due to various factors, such as lack of awareness of the availability of an eco-friendly product option. Promotions, such as ranking of products with higher eco-indicator scores in search results, etc., are used to create a slightly different experience for pro-environmental shopper segments geared towards promoting eco-friendly products based on the customer's eco-segment. For example, a customer in a lower eco-segment may not be willing to purchase a product that is harder to learn how to use. Therefore, even though the product has a higher eco-indicator score than other products, the product that is hard to learn how to use may be presented in a lower ranking by search rand ranking engine 208 to a customer in a pro-active or unsure eco-segment based on the purchases of other customers within the pro-active or unsure eco-segment. As another example, a customer in any one of the eco-segments may not be willing to purchase an eco-friendly product that is too expensive regardless of the product's eco-indicator score. Therefore, even though the product has a higher eco-indicator score than other products, the product that is more expensive may be presented in a lower ranking by search rand ranking engine 208 to a customer in a pro-active or unsure eco-segment based on the purchases of other customers within the pro-active or unsure eco-segment.

The eco-segments of customers determined by eco-segment customer classifier engine 206 can be stored in the customer data store 218 that can be accessed by other components or systems. For example, businesses can review the eco-segments for customers for business and product development purposes and may also view the promotions that are being provided to customers based on the eco-segment of the customer. As another example, search and ranking engine 208, customer demographic recommendation engine 210, price optimizing engine 212, and decoy product recommendation engine 214 may use the eco-segments of the customers and the customer data stored in customer data store 218 to determine the respective ranking of search results and recommendations.

The eco-segment customer classifier engine 206 can use customer interactions as feedback to optimize the machine learning model and update customer classifications. For example, the eco-segment of a customer may change over time. For instance, due to changes to in a customer's environmental behavior, a customer may be in a different eco-segment at different points in time. As can be appreciated, the eco-segment customer classifier engine 206 may store the initial set of eco-segments of customers via a data store, such as customer data store 218 and continuously or periodically update the eco-segments of customers over time.

The search and ranking engine 208 is generally configured to perform services related to generating and/or providing search results and, in particular, search results including eco-friendly products. As described herein, the search and ranking engine 208 can use online marketing and ranking approaches to boost sales of eco-friendly products in response to searches for products performed by a customer over less-eco-friendly products and non-eco-friendly products. Search and ranking engine 208 can include rules, conditions, associations, models, algorithms, or the like to provide rankings of products in response to search queries from customers. Search and ranking engine 208 may take on different forms depending on how the products are ranked in response to a customer's search. For example, search and ranking engine 208 may comprise a statistical model, fuzzy logic, neural network, finite state machine, support vector machine, logistic regression, clustering, or machine-learning techniques, similar statistical classification processes, or combinations of these to rank products to optimize the likelihood of a customer to purchase an eco-friendly product.

The search and ranking engine 208 can include business logic that algorithmically ranks sustainable products over similarly priced non-sustainable products. As can be appreciated, the search and ranking engine 208 can use eco-indicator product scores generated by the eco-indicator product score engine 204 and/or eco-segment classifications generated by the eco-segment customer classifier engine 206 to generate and/or rank search results (e.g., product search results). In some embodiments, the search and ranking engine 208 ranks the products based on the eco-indicator product score of the product alone. In some embodiments, the search and ranking engine 208 ranks the products based on the eco-indicator product score of the product and the eco-segment of the customer performing the search. In some embodiments, the search and ranking engine 208 ranks the products based on the eco-indicator product score of the product and subsequently re-ranks the products as a function of customer segments. In some embodiments, the search and ranking engine 208 can allow the boosting of eco-friendly products (e.g., products with a higher eco-indicator product score relative to other products), while also maintaining organic search results in a high ranking. In some embodiments, the boosting of eco-friendly products may be promoted based on a specific event, such as earth day. In some embodiments, the product with the highest eco-indicator product score would likely be recommended to the customer in the highest eco-segment. However, in some embodiments, the product with the highest eco-indicator product score may not be recommended to the customer in the highest eco-segment due to the other factors related to the likelihood of conversion of the product, such as the price of product and the customer's economic factors, and any other factors. Reinforcement learning may be utilized to learn the best set of products to be recommended to the best eco-segment of customers. As can be appreciated, any variation of eco-indicator product scores, customer eco-segment, product cost, etc. may be used to select or rank search results, such as products, to present to a user (e.g., in response to a search or as an advertisement).

In implementations in which the search and ranking engine 208 utilizes a machine learning model to generate and/or rank search results, the search and ranking engine 208 can use feedback to optimize the machine learning model. For example, a customer's selection of a specific product may be used to optimize the search and ranking engine 208, customer demographic recommendation engine 210, price optimizing engine 212, or decoy product recommendation engine 214. The customer's selection may also be feedback into the eco-segment customer classifier engine 206 to update the customer's eco-segment. In some embodiments, the search and ranking engine 208 can include a user interface component to allow an end user of the business to select how to rank certain products based on any of the embodiments described herein.

The customer demographic recommendation engine 210 is generally configured to provide eco-friendly product recommendations based on the customer demographic of an identified customer. The customer demographic can include the identified customer's eco-segment, geographical location, economic status, customer gender, customer age, or any other relevant demographic data collected regarding the customer. In this regard, the customer demographic recommendation engine 210 can influence individuals (e.g., customer/shoppers/consumers) to purchase eco-friendly products by providing recommendations or notifications of certain eco-friendly products within the customer's demographic (i.e., using social influence to illicit conversions). For instance, eco-friendly products resulting in conversions within a customer's identified eco-segment may be provided as a product recommendation (e.g., within a search platform, recommended product for an out of stock product, or as an advertisement). As another example, an indication may be provided on an e-commerce website as a product recommendation to a customer that shoppers in Austin, TX (i.e., the customer's geographic location) are buying a specific eco-friendly product. Customer demographic recommendation engine 210 can include rules, conditions, associations, models, algorithms, or the like to provide recommended products to a customer based on customer demographics. Customer demographic recommendation engine 210 may take on different forms depending on how products are recommended to customers. For example, customer demographic recommendation engine 210 may comprise a statistical model, fuzzy logic, neural network, finite state machine, support vector machine, logistic regression, clustering, or machine-learning techniques, similar statistical classification processes, or combinations of these to recommend products based on a customer demographic that optimizes the likelihood of a customer to purchase an eco-friendly product.

In embodiments in which the customer demographic recommendation engine 210 includes a machine learning model, the customer demographic recommendation engine 210 can use feedback to optimize the machine learning model. For example, a customer in a specific customer's segment selection of a specific product based on a customer demographic recommendation may be used to optimize the customer demographic recommendation engine 210, the search and ranking engine 208, price optimizing engine 212, or decoy product recommendation engine 214. In some embodiments, the customer's selection based on the recommendation of the customer demographic recommendation engine 210 may be feedback into the eco-segment customer classifier engine 206 to update the customer's eco-segment. In some embodiments, the customer demographic recommendation engine 210 can include a user interface component to allow an end user of the business to select how to recommend products based on a customer's demographic based on any of the embodiments described herein.

The price optimizing engine 212 is generally configured to determine optimal pricing strategies for eco-friendly products. Price optimizing engine 212 can include rules, conditions, associations, models, algorithms, or the like to optimize the price of an eco-friendly product. Price optimizing engine 212 may take on different forms depending on the mechanism used to determine the optimal price of an eco-friendly product. For example, price optimizing engine 212 may comprise a statistical model, fuzzy logic, neural network, finite state machine, support vector machine, logistic regression, clustering, or machine-learning techniques, similar statistical classification processes, or combinations of these to optimize the price of an eco-friendly product. In one embodiment, the price optimizing engine 212 may include NLP. In this regard, the price optimizing engine 212 may utilize NLP techniques to extract features from various customer data sources and product data sources in order to determine whether the price optimizing engine 212 is maximizing the features as described more fully below.

In some embodiments, the optimal pricing is performed using a MAB machine learning model, as described more fully below. Generally, a MAB machine learning model maximizes one or more key performance indicators (KPI), such as clicks for the product, purchases/conversions of the product, revenue, profit, units sold for the product, the number of customers that purchase the eco-friendly causing the customer to move up to a higher eco-segment, or any other KPIs for the product. As can be appreciated, the price optimizing engine 212 may utilize eco-indicator product scores and/or customer eco-segments to generate or optimize prices associated with products. In some embodiments, the price optimizing engine 212 is based on the eco-indicator product score. In some embodiments, the price optimizing engine 212 is not based on the eco-segment of the customer to maximize revenue across all customer segments. In some embodiments, the price optimizing engine 212 is based on the eco-segment of the customer to maximize revenue for the product based on the size of specific customer segment or if the price of the product causes customers to move into a different eco-segment in purchasing the product.

In some embodiments, in order to implement a pricing policy that is optimized for increasing conversions of eco-friendly products without knowing demand for the eco-friendly products in shopper segments a priori, the price optimizing engine 212 is implemented using a MAB machine learning model. In the MAB machine learning model, a single price for an eco-friendly product is proposed (i.e., pull a single arm of the MAB machine learning model) and the outcome resulting from this choice is observed (e.g., buy or refuse to buy, click of item or no click of item, etc.). The goal of the MAB machine learning model for eco-friendly products is to minimize the regret (i.e., the loss the merchandizer incurs when a suboptimal arm is chosen) while converging to the optimal price for the eco-friendly product. The MAB machine learning model balances exploration (i.e., trying a new price that has not been tried before) and exploitation (i.e., choosing a price that has yielded minimum regret from recent trials). The MAB machine learning algorithm will make subtle price differences to a product when a user is presented with multiple products in order to determine the optimal price that a user will select the eco-friendly products over the other products.

In some embodiments, the price optimizing engine 212 automatically updates the price of the product as the price changes to converge to the optimal price (e.g., the price optimizing engine automatically explores new prices for the product without approval of the business each time the price optimizing explores a new price). In some embodiments, the price optimizing engine 212 provides a notification for presentation in a user interface to the business to confirm whether to change the price of the product as the price changes to converge to the optimal price (e.g., the business approves the price proposed by the price optimizing engine to explore). In some embodiments, the price optimizing engine 212 provides a setting for presentation in a user interface to the business for selecting whether to automatically update the price or whether to require a confirmation by the business to update the price. In some embodiments, the price optimizing engine 212 can include a user interface component to allow an end user of the business to select whether to use the price optimizing engine or manually input a price.

The decoy product recommendation engine 214 is generally configured to utilize a decoy effect to nudge customers towards sustainable choices (i.e., eco-friendly products). In this regard, introducing a carefully constructed decoy product into a choice set can induce a shopper segment to shift their choices to sustainable products. The decoy can be a higher priced, low value (i.e., less-eco-friendly or a product that is not a good substitute for the product that the customer is searching for) item compared to other items in the choice set. For example, in scenarios where products added to the cart are unavailable or out of stock, shoppers can be provided with choice sets or substitution sets that model this decoy effect. The choice set can include a recommended product with a higher eco-indicator score and a decoy product. The decoy product helps steer attention of shoppers to sustainable products to further improve conversions. In another example, a default choice option (e.g., a pre-selected substitute product for an out of stock item that the customer has added to the cart) of a product with a higher eco-indicator score can be presented to a customer along with another non-default option for a decoy product. In this regard, the shopper is free to choose whichever option the shopper wants while abstaining to choosing an option results in the default, pre-selected option. Decoy product recommendation engine 214 can include rules, conditions, associations, models, algorithms, or the like to present a decoy product choice. The decoy product recommendation engine 214 may take on different forms depending on the mechanism used to present the decoy product choice. For example, decoy product recommendation engine 214 may comprise a statistical model, fuzzy logic, neural network, finite state machine, support vector machine, logistic regression, clustering, or machine-learning techniques, similar statistical classification processes, or combinations of these to identify the optimal decoy product choice.

In some embodiments, decoy product recommendation engine 214 may allow the business to enter the decoy product manually. In some embodiments, decoy product recommendation engine 214 may select the decoy product through a machine learning model, which can be trained based on feedback from the customer's product selection to select the optimal decoy product to result in the purchase of the recommended, eco-friendly product. In some embodiments, the decoy product may be different based on the customer segment of the customer. In some embodiments, the customer's selection based on the recommendation of the decoy product recommendation engine 214 may be feedback into the eco-segment customer classifier engine 206 to update the customer's eco-segment. In some embodiments, the customer's selection based on the recommendation of decoy product recommendation engine 214 may be used as feedback to optimize the machine learning model of the search and ranking engine 208, customer demographic recommendation engine 210, or price optimizing engine 212. In some embodiments, decoy product recommendation engine 214 can include a user interface component to allow an end user of the business to select whether to implement the decoy product recommendation engine 214 based on any of the embodiments described herein.

The eco-friendly product recommendation manager 202 can also include a machine learning model to determine the optimal amount of output to generate and/or provide in association with various engines (e.g., the eco-indicator score, customer demographic recommendation, decoy product recommendations, etc.). In this regard, the eco-friendly product recommendation manager 202 may identify or determine a type(s) of output to provide for presenting to a user (e.g., customer) in a user interface that would result in the highest likelihood of conversion of the eco-friendly products for a specific customer or customer segment. The eco-friendly product recommendation manager 202 can include rules, conditions, associations, models, algorithms, or the like to optimize the likelihood of conversion of the eco-friendly products for a specific customer or customer segment. The eco-friendly product recommendation manager 202 may take on different forms depending on the mechanism used to determine the optimal amount of engines. For example, eco-friendly product recommendation manager 202 may comprise a statistical model, fuzzy logic, neural network, finite state machine, support vector machine, logistic regression, clustering, or machine-learning techniques, similar statistical classification processes, or combinations of these to identify an optimal amount or type of output associated with various engines. For example, a particular customer segment may not wish to receive too many nudges from the engines to purchase an eco-friendly product, which may result in the customer not purchasing the product. In this regard, eco-friendly product recommendation manager 202 would learn to provide that particular customer segment less nudges from the engines. The eco-friendly product recommendation manager 202 may also enable a business entity to select which output or engines (i.e., the eco-indicator score, customer demographic recommendation, decoy product recommendations, etc.) to provide to the customer. For example, a particular business may decide it would like to set its own prices for its own products or the business may decide that it does not wish to provide decoy products to the customer. In this regard, the eco-friendly product recommendation manager 202 may only implement the engines selected by the business and disable the engines the business does not wish to utilize.

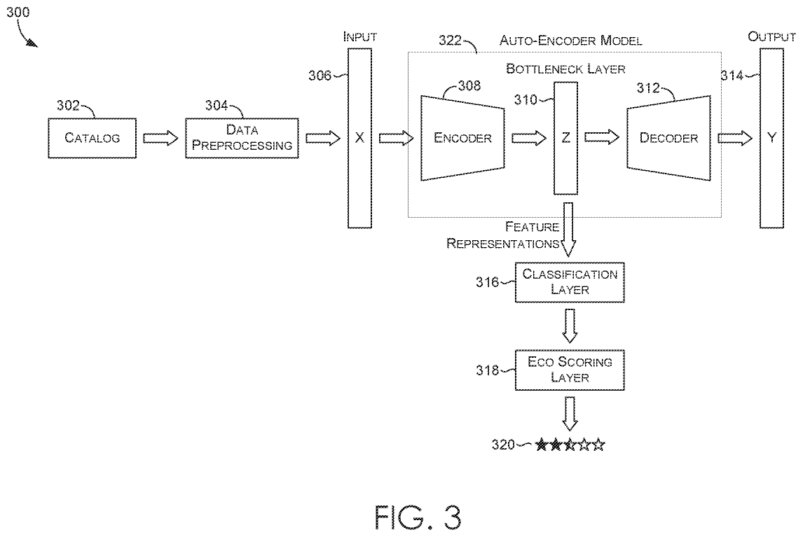

FIG. 3 provides an example flow diagram of an eco-indicator scoring system, in accordance with embodiments described herein. As described herein, such eco-indicator product scores can be used to increase conversions for eco-friendly products. Flow diagram 300 is an example flow diagram for an e-commerce eco-scoring system to output an eco-score for an input product. As shown at block 302, an input product description or one or more catalogs or sets of input product descriptions is obtained. At block 304, data preprocessing is applied to the product description(s). For example, in some cases, NLP may be applied to the product description(s). In this regards, the NLP may be utilized for lemmatization, removing stop words, normalizing data, and other NLP techniques in order to remove excess noise from the input product description(s). The preprocessed data is provided as input 306 into the auto-encoder model 322. The auto-encoder model 322 may be in the form of a machine learning model and trained based on an initial set of manually curated product descriptions. In some embodiments, the set of product descriptions can include a manually curated set of eco-friendly product descriptions. Alternatively or additionally, the set of product descriptions can include a manually curated set of non-eco-friendly product descriptions.

Input 306 enters the encoder layer 308 of auto-encoder model 322 where the preprocessed data of input 306 is compressed to the reduce dimensionality to the feature representations of bottleneck layer 310. The decoder layer 312 recreates or reconstructs the input 306 from the feature representations of bottleneck layer 310 as output 314. The auto-encoder model 322 is trained so that output 314 maintains the features necessary to indicate the eco-friendliness of the product from input 306, while efficiently reducing the dimensionality of input 306 to the feature representations of bottleneck layer 310. After the auto-encoder model 322 is trained, the decoder layer 312 and output 314 are not necessary for determining the eco-indicator score as the feature representations from bottleneck layer 310 represent the compressed and most efficient representation of the features of input 306 (from input product description(s) 302) to indicate the eco-friendliness of the product. Thus, after the auto-encoder model 322 is trained, the feature representations exit the auto-encoder model 322 through the bottleneck layer 310 and enter the classification layer 316.

After the feature representations of bottleneck layer 310 enter the classification layer 316, the classification layer 316 outputs a classification representing the eco-friendliness of the input product description(s) 302. The classification layer 316 is trained as a machine learning model to output a classification representing the eco-friendliness of the product using the feature representations output from the bottleneck layer 310 of the auto-encoder model 322. The classification layer is trained using the set of eco-friendly product descriptions and/or the set of non-eco-friendly product descriptions used to train the auto-encoder model 322. In some embodiments, the auto-encoder layer and classification layer can be trained separately. In some embodiments, the auto-encoder layer and the classification layer can be trained simultaneously.

In some embodiments, the classification layer 316 outputs a probability that a product is eco-friendly. The probability output by the classification layer for the input product enters scoring layer 318, which then assigns score 320 for the input product description(s) 302. The score shown in block 320 is shown for exemplary purposes only and may be any score on any scoring scale. For example, the eco-indicator score 320 may be any score on any given range, such as zero to five star rating where the inferred eco-friendliness of the product increases as the product's eco-indicator score approaches five stars. In some embodiments, the classification layer 316 may output a binary determination and the scoring layer 318 outputs whether a product is eco-friendly or non-eco-friendly in block 320. In some embodiments, the classification layer 316 may be a string that may indicate relative levels of the eco-friendliness of the input product, and the output 320 from the eco-scoring layer 318 is the level of eco-friendliness of the product. By using the auto-encoder model 322 and classification layer 316 of the machine learning model (or as separate machine learning models), merchants, who would not otherwise know that one of their products is eco-friendly, can use the machine learning model to identify the eco-friendliness of their products based on eco-friendly materials or processes within the product description of their product.

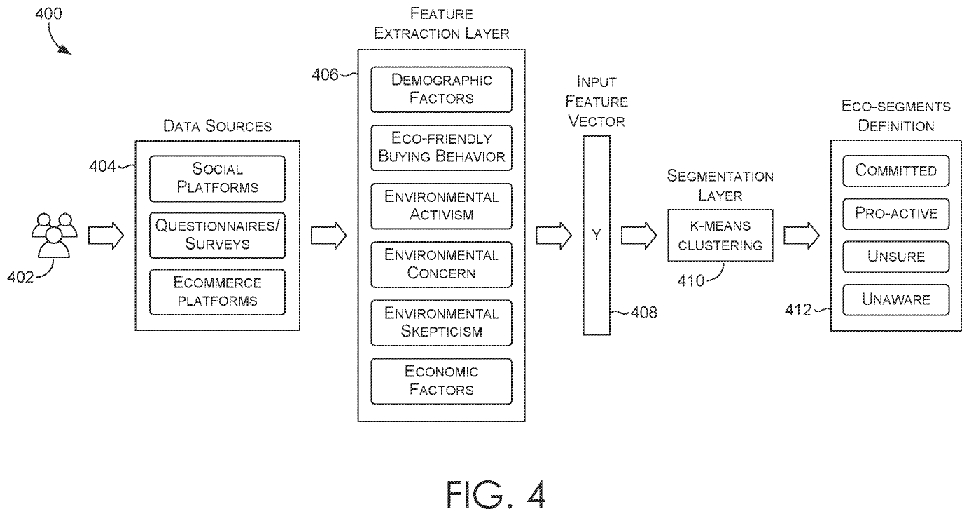

FIG. 4 provides an example flow diagram of an eco-segment customer classification system, in accordance with embodiments described herein. In embodiments, such eco-segment customer classifications are used to increase conversions for eco-friendly products, as described herein. Flow diagram 400 is one example of a flow diagram for segmentation of customers into eco-segments based on the customer's affinity for eco-friendly products. As shown, customers 402 interact with various data sources 404. Exemplary data sources 404 include social platforms, questionnaires/surveys, and e-commerce platforms, but can include any data source that provides data about the customer. Thereafter, the data from the data sources 404 are provided to a feature extraction layer 406 at which various features are extracted or identified. Exemplary features may include customer's data regarding the customer's demographic factors, eco-friendly buying behavior, environmental activism, environmental concern, environmental skepticism, and economic factors, but can include any customer data that may tend to indicate the customer's environmental behavior. An input feature vector 408 is generated based on various features extracted via the feature extraction layer 406. Such an input feature vector 408 is provided as input to the segmentation layer 410. The segmentation layer 410 uses a machine learning model, such as a k-means clustering model, to determine the eco-segments 412 of the customers. In some embodiments, the machine learning model is supervised, unsupervised, or a combination of both. As described, the segmentation layer predicts or outputs eco-segments associated with the customers. Exemplary eco-segments identifying the customer's affinity to eco-friendly products include committed, pro-active, unsure, and unaware, but can include any type or amount of eco-segments to determine the likelihood of whether a customer will purchase an eco-friendly product.

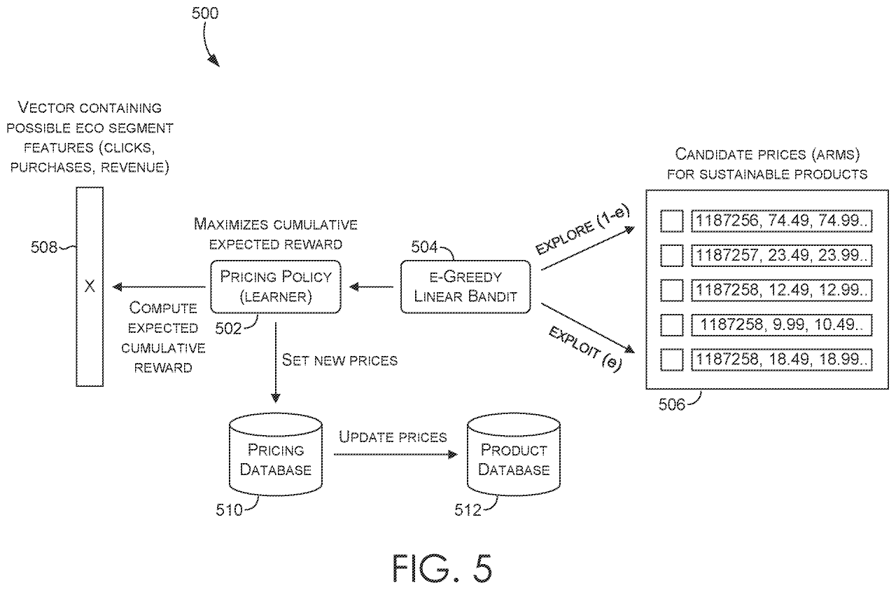

FIG. 5 provides an example flow diagram of an eco-friendly product pricing system for using machine learning to efficiently promote eco-friendly products to facilitate increasing conversions for eco-friendly products in an efficient and effective manner, in accordance with embodiments described herein. Flow diagram 500 is one example flow diagram for dynamic pricing for sustainable products to determine the optimal price for the eco-friendly product. A Pricing Policy Model 502 is implemented that maximizes cumulative expected reward of any amount of features of Feature Vector 508 based on subtle price changes of products proposed by MAB model 504. Feature Vector 508 may contain any features regarding the eco-friendly product, such as data regarding the clicks, purchases and profit/revenue of specific product. Further, Feature Vector 508 may include any KPI, any data indicating the likelihood or actual occurrence of the purchase of the specific eco-friendly product, or any data indicating the likelihood or actual occurrence of a customer purchasing an eco-friendly product. The cumulative expected reward determined by Pricing Policy Model 502 would maximize any amount of the features of Feature Vector 508 (i.e., maximizes revenue, clicks, purchases/conversions, profit, the number of customers that purchase the eco-friendly causing the customer to move up to a higher eco-segment, or etc. for the eco-friendly product based on the updated price for the product).

In the exemplary embodiment shown, the Pricing Policy Model 502 is a machine learning model that uses a MAB model 504 to explore and exploit Candidate Prices (i.e., arms of the MAB model) 506 for sustainable/eco-friendly products. As shown for exemplary purposes, the MAB model 504 is an epsilon-greedy linear bandit model, but can be any type of MAB model. As shown as an example of Candidate Prices 506 proposed by the MAB model 504, the MAB model 504 determines different prices to explore for different products (shown as example product numbers in block 506) over a period of time. Further, as shown as an example of Candidate Prices 506 proposed by the MAB model 504, the MAB model 504 determines different prices to exploit for different products over a period of time. The product numbers and prices shown in block 506 are shown for exemplary purposes only and may include any amount of products and any prices. As shown in the example of FIG. 5, the MAB model 504 proposes subtle price differences to Pricing Policy Model 502 to explore/exploit for the different products.

Feature Vector 508 is input into Pricing Policy Model 502 and Pricing Policy Model 502 learns the optimal price for an eco-friendly product to maximize the cumulative expected reward of any amount of features of Feature Vector 508. In order to determine the optimal price of the eco-friendly product, Pricing Policy Model 502 computes the cumulative expected reward 508 to determine whether an action (i.e., to exploit a new price proposed by MAB model 504) will maximize the cumulative expected reward 508 of any amount of specified features of Feature Vector 508. Based on the computation by the Pricing Policy Model 502 whether an action will maximize the cumulative expected reward, the Pricing Policy Model 502 sets the new prices in the Pricing Database 510 which updates the prices in the Product Database 512. For example, Pricing Policy Model 502 determines that a new price proposed by the MAB will maximize profit/revenue of a specific eco-friendly product and updates the price of the specific eco-friendly product accordingly. When a customer takes an action with respect to the specific eco-friendly product that updates Feature Vector 508, the updated Feature Vector 508 can be compared to original Feature Vector 508 to identify errors, which are backpropogated to train the Pricing Policy Model 508 as a continuous machine learning model. For example, if a customer searches for a product in Product Database 512 and chooses to purchase or not purchase the eco-friendly product, the action of the customer is used by Pricing Policy Model 508 to compute whether a new prices proposed by MAB 504 would maximize the cumulative expected reward and updates Pricing Database 510 and Product Database 512 accordingly.

In some embodiments, the prices are automatically updated by Pricing Policy Model 508. In some embodiments, the updating of the prices as Pricing Policy Model 508 implements new prices is subject to manual approval. In some embodiments, there may be a setting to automatically allow Pricing Policy Model 508 to update the price. In some embodiments, there can be a setting to receive a notification to manually approve the updated of the price as Pricing Policy Model 508 determines new prices.

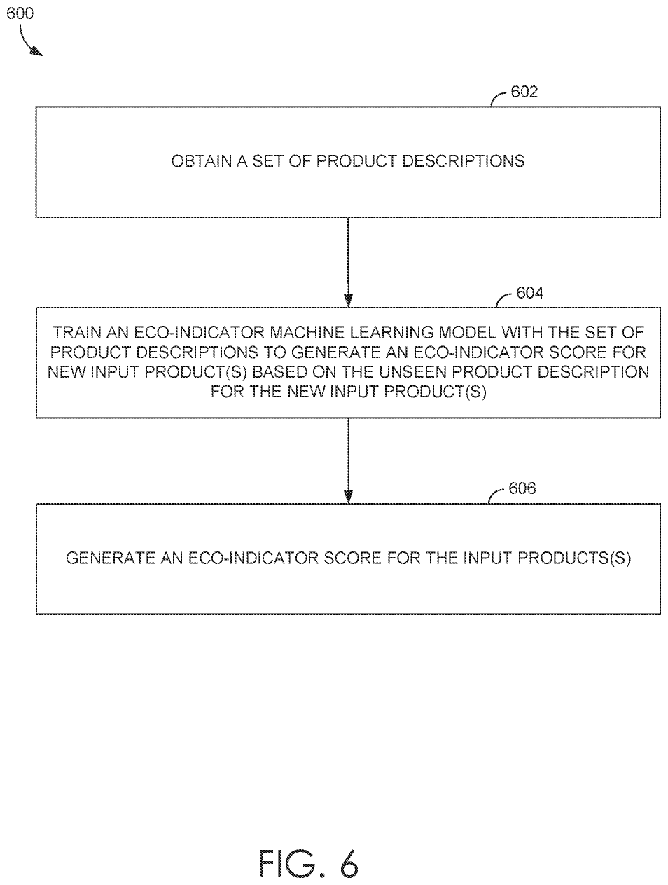

With reference now to FIGS. 6-11, FIGS. 6-11 provide method flows related to facilitating using machine learning to efficiently promote eco-friendly products, in accordance with embodiments of the present technology. Each block of method 600, 700, 800, 900, 1000 and 1100 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 6-11 are exemplary only and not intended to be limiting. As can be appreciated, in some embodiments, method flows 600-1100 can be implemented, at least in part, to facilitate using machine learning to efficiently promote eco-friendly products.

Turning initially to FIG. 6, a flow diagram 600 is provided showing an embodiment of a method 600 for generating eco-indicator scores for products in accordance with embodiments described herein. Eco-indicator scores for products can be used to increase conversions for eco-friendly products. Initially, at block 602, a set of product descriptions is obtained. In embodiments, each product description in the set of product descriptions includes subject matter indicating an environmental effect of a corresponding product. The set of product descriptions can be obtained in any number of ways. In some cases, the set of product descriptions can be a manually curated set of product descriptions. In some embodiments, the set of product descriptions includes a set of eco-friendly product descriptions where each eco-friendly product description includes subject matter where the environmental effect is deemed to be positive. In some embodiments, the set of product descriptions alternatively or additionally includes a set of non-eco-friendly product descriptions where each non-eco-friendly product description includes subject matter where the environmental effect is deemed to be negative.

At block 604, the set of product descriptions is used to train an eco-indicator machine learning model to generate an eco-indicator score for an input product based on the input product's corresponding unseen product description. The eco-indicator score is correlated to the environmental effect of the input product. For example, a product with a higher eco-indicator score would be more environmentally friendly than a product with a lower eco-indicator score. At block 606, the eco-indicator score is generated for the input product. In this regard, the eco-indicator score can be displayed to customers, marketers or the businesses selling the product to indicate the environmentally-friendliness of the product.

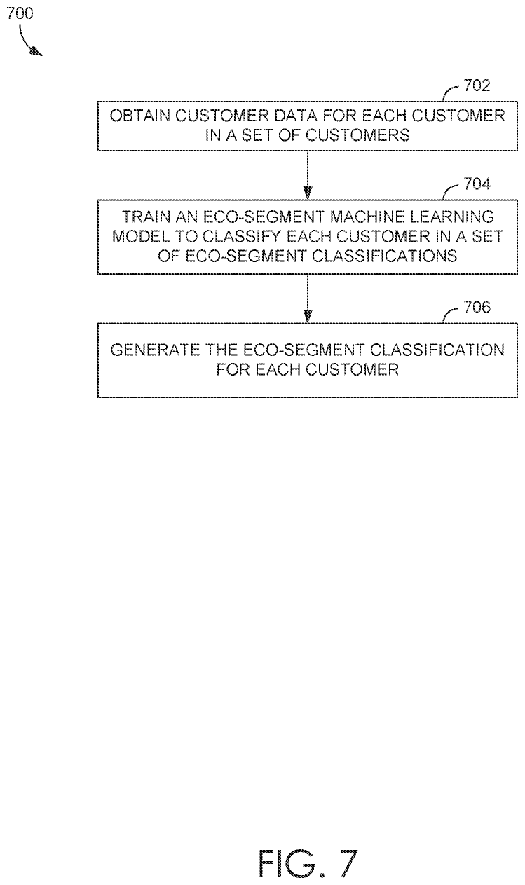

Turning now to FIG. 7, a flow diagram 700 is provided showing an embodiment of a method 700 for generating eco-segment classifications for customers in accordance with embodiments described herein. Eco-segment classifications for customers can be used to increase conversions for eco-friendly products. Initially, at block 702, customer data for each customer in a set of customers is obtained. In embodiments, the customer data for each customer in the set of customers includes subject matter indicating environmental behavior for each customer. The customer data can be obtained in any number of ways. In some cases, the customer data can be extracted from various sources such as social media platforms, e-commerce platforms, questionnaires or surveys, or any source of customer data. The customer data can include data regarding the customer demographic factors, eco-friendly product/service purchasing data, environmental activism, concern or skepticism, economic circumstances of the individual, and any other data which tends to show how an individual's habits with respect to the environment.

At block 704, the customer data is used to train an eco-segment machine learning model to classify or segment each customer in a set of eco-segment classifications. The eco-segment of each customer correlates to the likelihood of the customer engaging in positive environmental behavior. For example, customers may be segmented or classified into eco-segments identifying the customer's environmental behavior as likely committed, pro-active, unsure, unaware, or against purchasing eco-friendly products. At block 706, the eco-segment classification is generated for each customer. In this regard, the eco-segment classification can be displayed to marketers or the businesses selling the product to indicate the willingness of a customer to purchase an eco-friendly product.

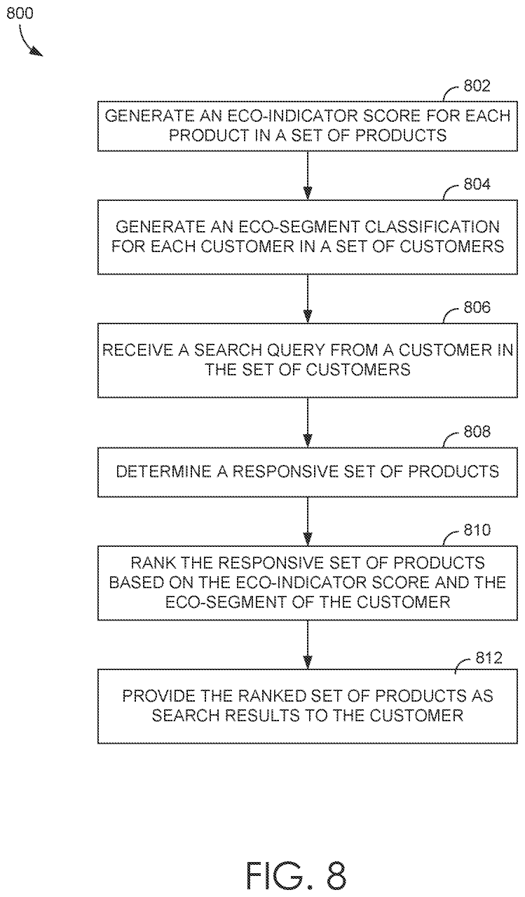

Turning now to FIG. 8, a flow diagram 800 is provided showing an embodiment of a method 800 for ranking search results for a search query from a customer based on the eco-indicator scores of products and the eco-segment of the customer in accordance with embodiments described herein. Ranking search results based on the eco-indicator scores of products and the eco-segment of the customer can be used to increase conversions for eco-friendly products. Initially, at block 802, an eco-indicator score is generated for each product in a set of products through an eco-indicator score machine learning model. In some embodiments, the eco-indicator machine learning model is trained by a set of product descriptions where each product description includes subject matter indicating an environmental effect of a corresponding product. At block 804, an eco-segment classification is generated for each customer in a set of customers through an eco-segment machine learning model. In some embodiments, the eco-segment machine learning model classifies each customer based on each customer's corresponding customer data where the customer data includes subject matter indicating environmental behavior for each customer.

At block 806, a search query is received by a customer in the set of customers. At block 808, a responsive set of products is determined in response to the search query. At block 810, the responsive set of products are ranked based on the eco-indicator score of the products and the eco-segment of the customer. In some embodiments, the responsive set of products is ranked based on the eco-indicator score of the products and then subsequently re-ranked based on the eco-segment of the customer or vice versa. In this regard, the most effective environmentally-friendly products can be provided to the specific customer based on the customer's eco-segment that most likely result in a conversion. At block 812, the ranked set of products (or re-ranked set of products) is provided to the customer in response to the customer's search query.

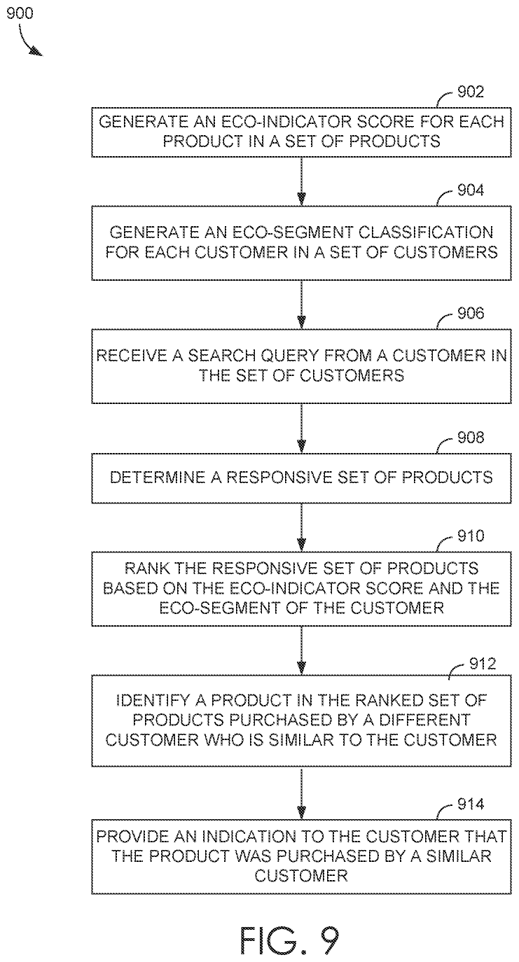

Turning now to FIG. 9, a flow diagram 900 is provided showing an embodiment of a method 900 for using social influence to elicit conversions of eco-friendly products in accordance with embodiments described herein. Social influence can be used to increase conversions for eco-friendly products. Initially, at block 902, an eco-indicator score is generated for each product in a set of products through an eco-indicator score machine learning model. At block 904, an eco-segment classification is generated for each customer in a set of customers through an eco-segment machine learning model. At block 906, a search query is received by a customer in the set of customers. At block 908, a responsive set of products is determined in response to the search query. At block 910, the responsive set of products are ranked based on the eco-indicator score of the products and the eco-segment of the customer. At block 912, a product is identified from the ranked set of products where the product was previously purchased by a different customer that has a similar portion of demographic data as the customer. For example, the customer and the different customer may be from the same geographic region or may be in the same age group. In block 914, an indication is provided to the customer that the product was purchased by a similar customer. For example, if the customer and the different customer are from the same geographic region, the indication that is provided may state that a customer in the same geographic region as you (i.e., the customer) purchased this product. In this regard, the customer would be more likely to purchase the eco-friendly product due to social influence. In some embodiments, the indication that a different customer with shared demographic data purchased the product may be provided for recommended products if a product added to a cart is unavailable or out of stock. In some embodiments, the indication that a different customer with shared demographic data purchased the product may be provided next a pre-selected, default choice to purchase a product.

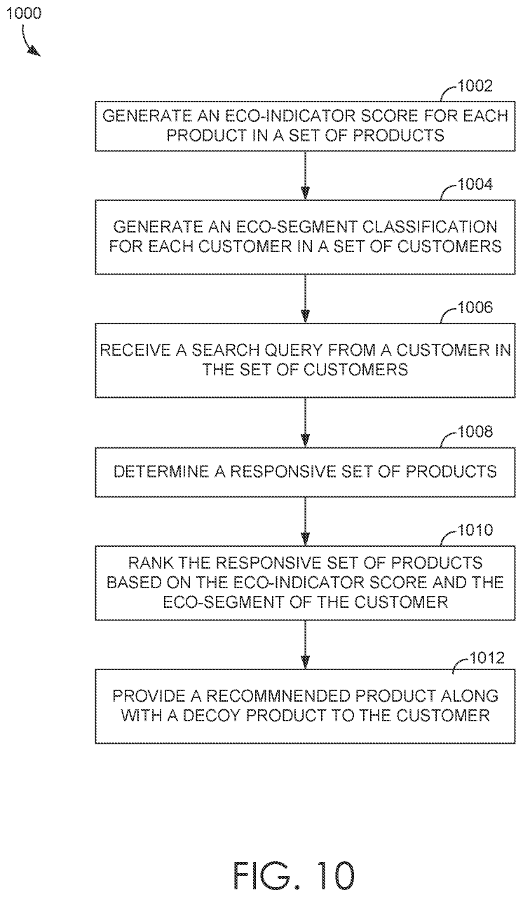

Turning now to FIG. 10, a flow diagram 1000 is provided showing an embodiment of a method 1000 for using decoy products to elicit conversions of eco-friendly products in accordance with embodiments described herein. Decoy products can be used to increase conversions for eco-friendly products. Initially, at block 1002, an eco-indicator score is generated for each product in a set of products through an eco-indicator score machine learning model. At block 1004, an eco-segment classification is generated for each customer in a set of customers through an eco-segment machine learning model. At block 1006, a search query is received by a customer in the set of customers. At block 1008, a responsive set of products is determined in response to the search query. At block 1010, the responsive set of products are ranked based on the eco-indicator score of the products and the eco-segment of the customer. At block 1012, a higher ranking, recommended product is provided to the customer along with a low-ranking, high priced competing decoy product. In this regard, the customer would be more likely to purchase the higher ranking (i.e., more eco-friendly) product when compared to the low-ranking (i.e., less eco-friendly or product that would not be a good substitute for the product that the customer is attempting to search for or purchase), but still high-priced decoy product. In some embodiments, the decoy product may be provided to the customer along with the recommended products if a product added to a cart is unavailable or out of stock. In some embodiments, the recommended product may be provided as a pre-selected, default choice next to the unselected decoy product. In this regard, the customer would be more likely to purchase the eco-friendly product. In some embodiments, the decoy product can be manually input across all segments or for specific segments. In some embodiments, a machine learning model may be used to identify the optimal decoy product for all segments or a specific segment in order to increase the likelihood of the customer to purchase the eco-friendly product.

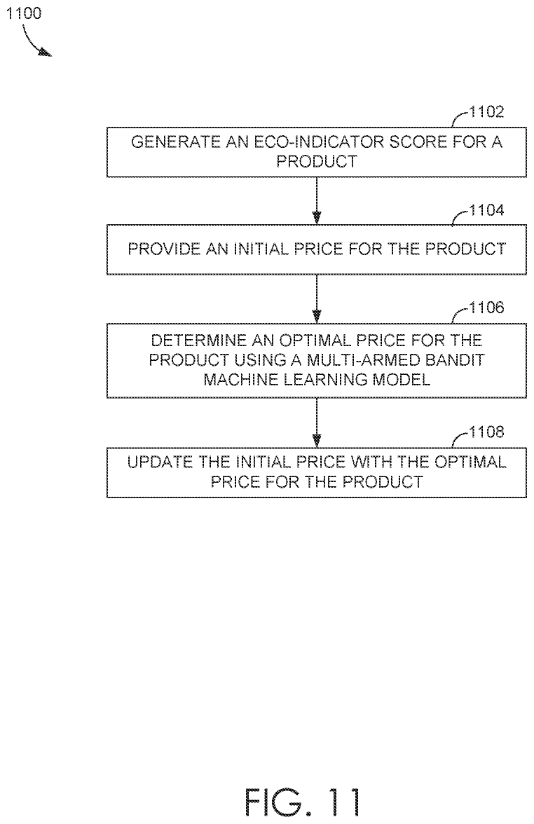

Turning now to FIG. 11, a flow diagram 1100 is provided showing an embodiment of a method 1100 for optimizing the price for eco-friendly products in accordance with embodiments described herein. Optimal pricing strategies can be used to increase conversions for eco-friendly products. Initially, at block 1102, an eco-indicator score is generated for a product through an eco-indicator score machine learning model. At block 1104, an initial price is provided for the product. The initial price may be provided in a number of ways. The initial price may be manually input or a machine learning model may input the initial price (automatically or subject to manual approval) by comparing the product to similar products. At block 1106, an optimal price for the product is determined using a MAB machine learning model. In this regard, the MAB machine learning model can be used to converge from an initial price to an optimal price. At block 1108, the initial price is updated with the optimal price for the product. In some embodiments, in changing the price of the product as the price converges from the initial price to the optimal price, as well as the updating of the initial price with the optimal price, an option may be provided to perform the price changes automatically or present a request for approval to change the price. In this regard, the optimal price to maximize revenue for the eco-friendly product can be utilized by the business.

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 12 in particular, an exemplary operating environment for implementing aspects of the technology described herein is shown and designated generally as computing device 1200. Computing device 1200 is just one example of a suitable computing environment and is not intended to suggest any limitation as to the scope of use or functionality of the technology described herein. Neither should the computing device 1200 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 12, computing device 1200 includes a bus 1210 that directly or indirectly couples the following devices: memory 1212, one or more processors 1214, one or more presentation components 1216, input/output (I/O) ports 1218, I/O components 1220, an illustrative power supply 1222, and a radio(s) 1224. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 12 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 12 and refer to “computer” or “computing device.”

Computing device 1200 typically includes a variety of computer-readable media. Computer-readable media can be any available media that can be accessed by computing device 1200 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1212 includes computer storage media in the form of volatile and/or nonvolatile memory. The memory 1212 may be removable, non-removable, or a combination thereof. Exemplary memory includes solid-state memory, hard drives, and optical-disc drives. Computing device 1200 includes one or more processors 1214 that read data from various entities such as bus 1210, memory 1212, or I/O components 1220. Presentation component(s) 1216 present data indications to a user or other device. Exemplary presentation components 1216 include a display device, speaker, printing component, and vibrating component. I/O port(s) 1218 allow computing device 1200 to be logically coupled to other devices including I/O components 1220, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1214 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 1200. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1200. The computing device 1200 may be equipped with depth cameras, such as stereoscopic camera systems, infrared camera systems, RGB camera systems, and combinations of these, for gesture detection and recognition. Additionally, the computing device 1200 may be equipped with accelerometers or gyroscopes that enable detection of motion. The output of the accelerometers or gyroscopes may be provided to the display of the computing device 1200 to render immersive augmented reality or virtual reality.

A computing device may include radio(s) 1224. The radio 1224 transmits and receives radio communications. The computing device may be a wireless terminal adapted to receive communications and media over various wireless networks. Computing device 1200 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. A computer-implemented method comprising:
obtaining a product description associated with a product, wherein the product description includes subject matter indicating an environmental effect of the product;
generating, via a machine learning model, a score for the product based on the product description of the product, wherein the score for the product is correlated to the environmental effect of the product; and
providing the score for presentation to indicate the correlated environmental effect of the product.

2. The computer-implemented method of claim 1, wherein the score is generated via the machine learning model through a trained classification machine learning model and a trained auto-encoder machine learning model.

3. The computer-implemented method of claim 2, wherein the score is generated via the machine learning model by scoring a classification output by the 1 trained classification machine learning model.

4. The computer-implemented method of claim 1, wherein the machine learning model is trained by a set of product descriptions, wherein each product description in the set of product descriptions includes subject matter indicating an environmental effect of a corresponding product.

5. The computer-implemented method of claim 4, further comprising:
wherein the set of product descriptions comprises a set of eco-friendly product descriptions, wherein each eco-friendly product description in the set of eco-friendly product descriptions includes subject matter where the environmental effect is deemed to be positive; and
wherein the set of product descriptions further comprises a set of non-eco-friendly product descriptions, wherein each non-eco-friendly product description in the set of non-eco-friendly product descriptions includes subject matter where the environmental effect is deemed to be negative.

6. The computer-implemented method of claim 1, further comprising:
receiving a search query;
determining a responsive set of products in response to the search query, wherein the responsive set of products includes the product; and
wherein the score is provided for presentation with the product in the responsive set of products.

7. The computer-implemented method of claim 1, further comprising:
obtaining a set of product descriptions, wherein each product description in the set of product descriptions is associated with a corresponding product in a set of products and each product description includes subject matter indicating an environmental effect of the product;
generating, via the machine learning model, a corresponding score for each product in the set of products based on its corresponding product description, wherein the score for the product is correlated to the environmental effect of the product;
receiving a search query;
determining a responsive set of products in response to the search query;
ranking the responsive set of products based on the corresponding score of each product in the responsive set of products; and
wherein the score is provided for presentation with the ranked responsive set of products in response to the search query.

8. The computer-implemented method of claim 1, further comprising:
receiving an out of stock indication;
determining the product to be a recommended product in response to the out of stock indication and wherein the score is provided for presentation along with the product as the recommended product; and
further providing a decoy product for presentation in response to the out of stock indication, wherein the decoy product is a different product than the product and determined to be an alternative recommended product and wherein the decoy product's score is below a threshold value and a price of the decoy product is above a threshold price.

9. The computer-implemented method of claim 1, further comprising:
providing an initial price for the product;
determining, using a multi-armed bandit model, an optimal price for the product based at least in part on the score of the product; and
updating the initial price with the optimal price for the product.

10. One or more computer-readable media having a plurality of executable instructions embodied thereon, which, when executed by one or more processors, cause the one or more processors to perform a method comprising:
obtaining customer data for each customer in a set of customers, wherein the customer data includes subject matter indicating environmental behavior for each customer;
classifying, via a machine learning model, each customer into a set of segments based on each customer's corresponding customer data, wherein the set of segments correlate to the likelihood of the customer engaging in positive environmental behavior; and
providing products for presentation based on at least one segment in the set of segments.

11. The media of claim 10, wherein the products are provided for presentation to a customer searching for products or a business providing the products.

12. The media of claim 10, wherein the method further comprises:
generating, via a second machine learning model, a score for each product in a set of products, wherein the score for the product is correlated to the environmental effect of the product; and
wherein the products are provided for presentation further based on the score for the products.

13. The media of claim 12, wherein the second machine learning model is trained by a set of product descriptions, wherein each product description in the set of product descriptions includes subject matter indicating an environmental effect of a corresponding product.

14. The media of claim 12, wherein the method further comprises:
receiving a search query from a customer;
determining a responsive set of products from the set of products in response to the search query;
ranking the responsive set of products based on the score of each product in the responsive set of products and segment of the customer; and
wherein the products are provided for presentation to the customer and comprises providing the ranked responsive set of products in response to the search query.

15. The media of claim 14, wherein the ranking comprises:
initially ranking the responsive set of products based on the score of each product in the responsive set of products; and
re-ranking the initially ranked responsive set of products based on the segment of the customer.

16. The media of claim 14, wherein the method further comprises:
wherein the customer data for each customer in a set of customers further comprises demographic data;
identifying a product in the ranked responsive set of products above a threshold ranking purchased by a different customer in the set of customers, wherein at least a portion of the demographic data of the different customer is similar to demographic data of the customer; and
wherein the providing products for presentation to the customer further comprises providing an indication that the product was purchased by others with similar demographic data.

17. The media of claim 14, wherein the providing products for presentation to the customer further comprises:
providing a recommended product in response to the search query, wherein the recommended product is a product in the ranked responsive set of products whose score is above a threshold value; and
further providing a decoy product in response to the search query, wherein the decoy product is a different product in the ranked responsive set of products whose score is below the threshold value and a price of the different product is above a threshold price.

18. A computing system comprising:
a processor; and
a non-transitory computer-readable medium having stored thereon instructions that when executed by the processor, cause the processor to perform operations including:
generating, via a first machine learning model, a score for each product in a set of products, wherein the score for the product is correlated to the environmental effect of the product;
classifying, via a second machine learning model, a customer into a segment of a set of segments, wherein the set of segments correlate to the likelihood of the customer engaging in positive environmental behavior;
receiving a search query from the customer;
determining a responsive set of products from the set of products in response to the search query;
ranking the responsive set of products based on the score of each product in the responsive set of products and based on the segment of the customer; and
providing the ranked responsive set of products in response to the search query.

19. The system of claim 18, wherein:
the first machine learning model is trained by a set of product descriptions, wherein each product description in the set of product descriptions includes subject matter indicating an environmental effect of a corresponding product; and
the second machine learning model classifies each customer in a set of customers into the set of segments through customer data for each customer in the set of customers, wherein the customer data includes subject matter indicating environmental behavior for each customer.

20. The system of claim 18, wherein the ranking comprises:
initially ranking the responsive set of products based on the score of each product in the responsive set of products; and
re-ranking the initially ranked responsive set of products based on the segment of the customer.
